(19) United States
(12) Patent Application Publication
(10) Pub. No.: US 2002/0198964 A1
(43) Pub. Date: Dec. 26, 2002

(54) Method and system for wireless remote monitoring and control of a manufacturing execution system

(75) Inventors: Susumu Fukazawa, Tokyo (JP); Perry G. Hartswick, Millbrook, NY (US); Ryuhji Tamehiro, Kuastsu-shi (JP); Yuji Tomita, Chiba (JP); David L. Travagline, Wappingers Falls, NY (US)

Correspondence Address: DELIO & PETERSON, LLC, 121 WHITNEY AVENUE, NEW HAVEN, CT, 06510, US

(73) Assignee: International Business Machines Corporation, Armonk, NY

(21) Appl. No.: 09/891,896

(22) Filed: Jun. 26, 2001

(51) Int. Cl. G06F 19/00

(52) U.S. Cl. 709/219; 700/96

(57) ABSTRACT

A method of remotely monitoring and controlling a manufacturing facility through a manufacturing execution system (MES) uses wireless devices connected to a web server through a transcoding proxy. The wireless devices, such as portable digital assistants or cell phones, request information about the manufacturing process from the web server by requesting web pages containing the desired information. The web pages are modified by the transcoding proxy so that they may be correctly displayed on the screen of the wireless device. The MES can also be controlled by a wireless device. The wireless device passes control commands through the transcoding proxy to the web server, which sends them to the MES to control production in the manufacturing facility.

### BACKGROUND OF THE INVENTION

1. Field of the Invention

The present invention relates to remotely monitoring and controlling manufacturing operations using wireless communication technology.

2. Description of Related Art

Manufacturing Execution Systems (MES) have been designed to control the manufacture of a wide variety of products, including microelectronic devices, food products, pharmaceuticals and other mechanical and electrical devices. Manufacturing execution systems include software to control the manufacturing process and record data concerning the processing parameters and status of work as it moves towards completion.

The MES software runs on a computer connected to sensors and control devices located throughout the manufacturing facility to monitor and control the manufacturing operation. The user of the system may control and monitor the manufacturing process directly through the computer running the MES software. Alternatively, the computer running the MES software may act as an MES server and one or more users will control and monitor the process through other computers or terminals located in the manufacturing facility that communicate with the MES server.

These MES designs require that the engineer or manager in charge of the system be physically located within the manufacturing facility to access the MES system. It is not always possible or convenient for the user to be in the manufacturing facility, and this can lead to manufacturing delays, defects in the product being produced and other problems related to the inability of the user to timely access critical information about the manufacturing process.

To alleviate this problem, MES systems have been designed to interface with the Internet using standard web server technology so that the users of the system can access manufacturing status information from any conventional computer. The user can obtain critical information about the manufacturing process on a timely basis from any computer that has a conventional web browser and a connection to the Internet. An example of a system of this type is found in U.S. Pat. No. 5,847,957, which describes an MES system providing access by customers to limited information about the manufacturing status of products.

However, these web-enabled MES systems still suffer from the defect that they do not allow control of the manufacturing process. They only allow review of status information and still require that someone having direct access to the MES system at the manufacturing site enter control changes.

Another problem with existing web-enabled MES systems is that the user must have access to a conventional Internet-connected computer running a conventional web browser just to obtain the desired status information. This is inconvenient, and for time-critical manufacturing processes, it may not be possible for a user who is in transit, or out in the field, to get to such a computer on a timely basis.

Bearing in mind the problems and deficiencies of the prior art, it is therefore an object of the present invention to provide a method of remotely monitoring and controlling a manufacturing execution system through a wireless device.

Still other objects and advantages of the invention will in part be obvious and will in part be apparent from the specification.

### SUMMARY OF THE INVENTION

The above and other objects and advantages, which will be apparent to one of skill in the art, are achieved in the present invention, which is directed to, in a first aspect, a method of remotely monitoring and controlling a manufacturing execution system. The method includes the steps of:

providing a web server connected to the manufacturing execution system, the manufacturing execution system providing information to the web server and receiving control data from the web server;

providing a transcoding proxy connected to the web server;

receiving a request at the transcoding proxy from a wireless device, the request including wireless device data and request data, the wireless device data including information about the wireless device and the request data identifying information requested from the manufacturing execution system;

sending the request data from the transcoding proxy to the web server;

receiving a response from the web server at the transcoding proxy, the response including information responsive to the request data;

modifying the response at the transcoding proxy, based on the wireless device data, to a format compatible with the wireless device;

sending the modified response from the transcoding proxy to the wireless device;

sending a control command containing control data from the wireless device to the transcoding proxy;

relaying the control data from the transcoding proxy to the web server; and

forwarding the control data from the web server to the manufacturing execution system to control operation of the manufacturing execution system.

In another aspect of the invention, the method includes storing the wireless device data at the transcoding proxy and retrieving the wireless device data before modifying the response based on the wireless device data. A wireless access point is connected to the transcoding proxy, the wireless device sending the request to the transcoding proxy via the wireless access point.

Preferably, the request data is a request for a web page from the web server and the information responsive to the request comprises a web page encoded in hypertext markup or extended markup language format. The wireless device may be a wireless personal digital assistant, a cell phone or any other type of wireless device.

The invention is also directed to a system for remotely monitoring and controlling production at a manufacturing facility that includes a manufacturing execution system, a web server and a transcoding proxy. The manufacturing execution system is connected to monitor and control the manufacturing facility. The web server is connected to the manufacturing execution system, the manufacturing execution system providing information to the web server and receiving control data from the web server. The transcoding proxy is connected to the web server, the transcoding proxy being adapted to receive a request from a wireless device, the request including wireless device data and request data, the wireless device data including information about the wireless device and the request data identifying information requested from the manufacturing execution system.

The transcoding proxy sends the request data to the web server, responsive to receipt of the request from the wireless device. The web server sends a response to the transcoding proxy, the response including information responsive to the request data. The transcoding proxy then modifies the response, based on the wireless device data, to a format compatible with the wireless device. The transcoding proxy then sends the modified response from the transcoding proxy to the wireless device.

The transcoding proxy is also adapted to receive a control command containing control data from the wireless device. The control data is relayed by the transcoding proxy to the web server and the web server forwards the control data from the web server to the manufacturing execution system to control operation of the manufacturing facility through the manufacturing execution system.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 is a flow diagram showing the principal parts of the system of this invention and the flow of information and control commands between those parts in accordance with the method of this invention.

### DESCRIPTION OF THE PREFERRED EMBODIMENT(S)

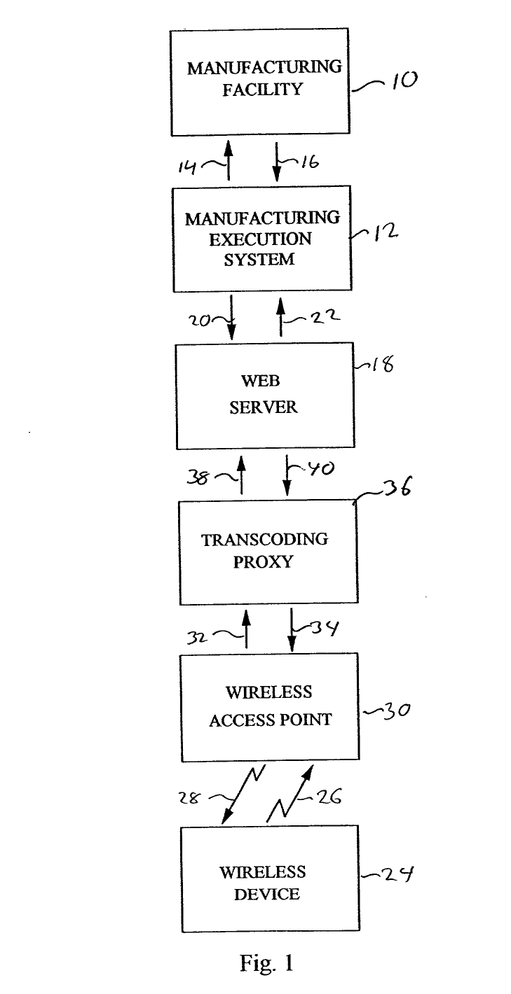

In describing the preferred embodiment of the present invention, reference will be made herein to FIG. 1 of the drawings in which like numerals refer to like features of the invention. Features of the invention are not necessarily shown to scale in the drawings.

Referring to FIG. 1, a manufacturing facility 10 is controlled by a manufacturing execution system 12. The manufacturing facility may manufacture semiconductor devices, electronic products, pharmaceuticals or any other type of product. The manufacturing execution system is preferably a conventional computerized manufacturing execution system that receives inputs from sensors located throughout the manufacturing facility and digitally controls manufacturing variables such as processing times, temperatures, flow rates, etc.

For example, the manufacturing facility 10 may be a semiconductor manufacturing facility and the manufacturing execution system may be a conventional MES system such as SiView, sold by the assignee of the present invention, International Business Machines Corporation.

The manufacturing execution system 12 is preferably connected to the manufacturing facility with a high speed digital network. Control communication sent from the MES system 12 to the manufacturing facility 10 is indicated with reference number 14. Monitoring communication comprising information sent from the manufacturing facility 10 to the MES system 12 is indicated with reference number 16.

Those with skill in the art will recognize that two way communication between the MES and the manufacturing facility is required for both control communication and monitoring communication and that such two-way communication generally occurs in packets sent over a communication data bus or channel capable of sending and receiving such packets. The directional arrows used herein, such as those labeled with reference numbers 14 and 16 are not meant to imply only one way communication, nor are they meant to imply separate wires or separate physical communication channels. They are provided to indicate that both control and monitoring information may be sent where indicated as needed to actually control the operation of the manufacturing facility or as needed to monitor the operation of the manufacturing facility.

In a conventional MES design that is not web-enabled, users of the manufacturing execution system are located within the manufacturing facility and use desktop computers or fixed computer terminals to access an MES server running the MES software necessary to implement the monitoring and control functions of the MES system. It is contemplated that in the present invention, such direct control of the MES 12 will also be possible in accordance with the conventional features of existing MES systems.

In a conventional web-enabled MES design, a web server is provided, which provides monitoring functionality, but not control functionality, over a computer network, such as the Internet or a local intranet. Monitoring functionality via the web server has been provided through conventional web pages and HTTP (hypertext transfer protocol) communication. The present invention also includes a web server 18 that can receive monitoring information (indicated with arrow 20) from the MES. Accordingly, the web server 18 of this invention can provide the known function of monitoring the manufacturing operation by the web. However, the web server 18 of the present invention has been enhanced to allow control of the manufacturing operation via control communication 22.

Both control 22 and monitoring 20 communication is provided through HTTP protocol and web pages encoded in HTML (hypertext markup language) or XML (extended markup language). It is contemplated, however that other types of protocols and languages may be used to implement the control and monitoring operation of this invention.

The web-enabled MES system of the present invention includes multiple web pages stored and updated by the web server 18, or created by the web server on demand, that contain critical manufacturing information needed by the system users to run the manufacturing facility. By requesting these web pages using a conventional computer running a conventional web browser, such as Netscape or Internet Explorer, the user can obtain the needed information.

In the present invention, the control functionality is implemented by entering information onto interactive web pages maintained by the web server 18. For example, if a user wants to clear an equipment alarm or release an inhibit on a job to continue at a subsequent processing step, a corresponding web page would permit entry of the newly desired equipment alarm, job inhibit or release authorization. The web server will then take the information from the interactive web page and send it via communication channel 22 to the MES 12, which will then control the manufacturing facility 10 over communication channel 14.

The web server 18 will generally comprise a computer running web server software. The web server software may be conventional web server software or it may be software integrated into the MES system 12. The web server software may run on the same computer running the MES software, or it may run on a separate computer.

It is contemplated that the web server 18 will also include specialized software and application programming interfaces (APIs) for communicating with the manufacturing execution system 12 and for converting control data entered into web pages on the web server 18 into corresponding control commands containing the control data needed to control the manufacturing execution system 12. Such APIs, conversion software and related software necessary to implement the control of the MES by the web server will depend upon the particular MES system, however all such software can be written by those with ordinary skill in the art.

The web server 18 of the present invention will respond conventionally to HTTP requests from conventional computers connected via wire through the Internet, or a local intranet, and running conventional web browser software. However, in the present invention, the system is specially designed for monitoring and control by wireless devices as well as conventional desktop computers.

A wireless device 24 sends control communication 26 and receives monitoring information 28. The communication 26 and 28 occurs wirelessly between the wireless device 24 and wireless access point 30. The wireless access point may be an infrared, radio frequency or other type of conventional wireless access point located within the manufacturing facility 10, or it may be a public wireless access point, such as a cell phone tower located anywhere in the world. The wireless device 24 may be a personal digital assistant (PDA), a cell phone or any other type of digital wireless device. Conventional communication protocols such as 802.11a, 802.11b, BlueTooth, CDPD or any other type of wireless communication protocols may be used.

The wireless access point 30 provides control 32 and monitoring 34 communication with a transcoding proxy 36. The principal function of the transcoding proxy 36 is to understand the characteristics and limitations of the type of wireless device attempting to communicate with the web server 18 and to modify web pages provided by the web server so that they can be displayed and accessed by different types of wireless devices. Some wireless devices have very limited screen resolutions or very small screens. Others do not offer color or cannot display graphics. The transcoding proxy 36 addresses these problems by identifying the limitations of the wireless device and appropriately modifying the requested web page.

Suitable transcoding proxy software packages are presently available from various sources for implementing the transcoding proxy function of the present invention. The transcoding proxy will generally comprise a computer running transcoding proxy software. The computer running the transcoding proxy software may be the same computer running the web server software or it may be a separate computer. The transcoding proxy provides both control 38 and monitoring 40 communication capability with the web server 18.

The invention may be implemented such that computers that do not need the services of the transcoding proxy send requests directly to the web server. However, it may also be implemented such that the transcoding proxy receives all requests directed to the web server, including requests from web browser software on computers connected via wires to the computer network. There may be multiple network connection paths to the transcoding proxy, including connections via the Internet, as well as via a local intranet.

A typical monitoring and control session with a wireless device will begin when a user, charged with responsibility for monitoring and controlling the operation of manufacturing facility 10, uses a wireless device 24 to contact the web server 18. The users of the system will use their wireless devices in substantially the same way they use the devices to browse the World Wide Web through the Internet.

A user will initially make a connection through a wireless access point 30 and log in though any access or security procedures implemented. The user will then send a request for a specific web page stored on web server 18 containing information necessary for monitoring the operation of manufacturing facility 10. The request will pass through the transcoding proxy 36.

The request from the user will include wireless device data and request data, however the two forms of data need not be in transmitted at the same time or in the same digital packet. The “wireless device data” allows the transcoding proxy to identify the characteristics of the wireless device, such as the screen resolution of the device. The wireless device data may be an identifier indicating the type of device, allowing the transcoding proxy to identify the device characteristics from previously stored information, or it may be specific detailed information defining the wireless device characteristics, or it may be any other method of allowing the transcoding proxy to determine the characteristics of the wireless device that limit the way in which web pages are displayed, sound is played or multimedia content is handled.

The “request data” will typically be the location of the desired web page containing the desired information. However, it may be data entered into a generic interactive web page defining the information requested from the manufacturing execution system 12.

The transcoding proxy 36 will save information from the request that identifies the device making the request. This allows the transcoding proxy to identify the response and determine how to modify the response so that it can be displayed on the originating wireless device. The transcoding proxy then sends the request data on to the web server and requests the web page containing the desired information. The web server 18 may be designed to constantly refresh web pages containing critical information or it may receive the request and, responsive to the request, contact the MES system 12 for updated information.

Regardless of how the information is obtained, the web server 18 will ultimately send a response, preferably as an HTTP protocol response comprising an HTML or XML encoded web page. As is well known, web pages may contain text, images, such as GIF or JPEG images, sound and any other type of multimedia data. The responsive web page is sent by the web server back to the transcoding proxy 36.

The transcoding proxy retrieves the previously stored device data identifying the originating wireless device and then uses that device data to determine the characteristics of the wireless device. Based on those characteristics, or any other characteristics or limitations of the wireless device known to the transcoding proxy, the transcoding proxy modifies the response. Typically the modification might include reformatting or changing the font on the web page being returned, removing or revising graphics, and making other changes to text, graphics, sound or other multimedia components of the web page to accommodate the characteristics of the wireless device.

The transcoding proxy then sends the modified response to the wireless device through the wireless access point. The wireless device displays the web page, plays the sounds, and provides the requested information to the uses so that the user may monitor the operation of the manufacturing process.

In addition to monitoring the operation of the manufacturing process, in the present invention, the user is able to control the operation of the manufacturing process. The control is accomplished by sending a control command, preferably by entering information into an interactive web page. The interactive web page may be a separate web page, however, it is preferred that it be the same web page originally requested that displays the requested information used to make the control decision.

Typically the displayed web page will include a location for entering control information, such as changing equipment status, clearing equipment alarms, releasing job inhibits or other production or process related functions. The user then sends the control command in the form of the control data entered into the interactive web page through the wireless access point to the transcoding proxy 36. The control data is relayed from the transcoding proxy 36 to the web server 18 and then forwarded from the web server to the manufacturing execution system 12 to control the production.

It is expected that in many cases the wireless access point 30 will be located within the manufacturing facility. This allows the user to roam through the facility and still remain in control of production. However, the wireless access point may comprise a cellular telephone or even a satellite system. and the link from the wireless access point 30 may be through portions of the public switched telephone network. It is also expected that the web server 18 will be accessible through the Internet or a local intranet via conventional hard-wired computers.

There will also be extensive security procedures implemented to ensure that the individual accessing the web server is authorized to control the production of the manufacturing facility 10.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A method of remotely monitoring and controlling a manufacturing execution system comprising the steps of:
providing a web server connected to the manufacturing execution system, the manufacturing execution system providing information to the web server and receiving control data from the web server;
providing a transcoding proxy connected to the web server;
receiving a request at the transcoding proxy from a wireless device, the request including wireless device data and request data, the wireless device data including information about the wireless device and the request data identifying information requested from the manufacturing execution system;
sending the request data from the transcoding proxy to the web server;
receiving a response from the web server at the transcoding proxy, the response including information responsive to the request data;
modifying the response at the transcoding proxy, based on the wireless device data, to a format compatible with the wireless device;
sending the modified response from the transcoding proxy to the wireless device;
sending a control command containing control data from the wireless device to the transcoding proxy;
relaying the control data from the transcoding proxy to the web server; and
forwarding the control data from the web server to the manufacturing execution system to control operation of the manufacturing execution system.

2. The method of remotely monitoring and controlling a manufacturing execution system according to claim 1 further including the steps of:
storing the wireless device data at the transcoding proxy; and
retrieving the wireless device data before modifying the response based on the wireless device data.

3. The method of remotely monitoring and controlling a manufacturing execution system according to claim 1 further including the step of providing a wireless access point connected to the transcoding proxy, the wireless device sending the request to the transcoding proxy via the wireless access point.

4. The method of remotely monitoring and controlling a manufacturing execution system according to claim 3 wherein the manufacturing execution system and the wireless access point are located in a manufacturing facility being controlled by the manufacturing execution system.

5. The method of remotely monitoring and controlling a manufacturing execution system according to claim 1 wherein the transcoding proxy is connected to a computer network and the transcoding proxy receives requests from web browser software on computers connected via wires to the computer network.

6. The method of remotely monitoring and controlling a manufacturing execution system according to claim 1 wherein the request data comprises a request for a web page from the web server.

7. The method of remotely monitoring and controlling a manufacturing execution system according to claim 6 wherein the information responsive to the request comprises a web page encoded in extended markup language format.

8. The method of remotely monitoring and controlling a manufacturing execution system according to claim 1 wherein the manufacturing execution system controls a facility for manufacturing semiconductor devices.

9 The method of remotely monitoring and controlling a manufacturing execution system according to claim 1 wherein the wireless device is a wireless personal digital assistant.

10. The method of remotely monitoring and controlling a manufacturing execution system according to claim 1 wherein the wireless device is a cell phone.

11. The method of remotely monitoring and controlling a manufacturing execution system according to claim 1 wherein the request is sent from the wireless device to the transcoding proxy via a conventional wireless communication protocol.

12. The method of remotely monitoring and controlling a manufacturing execution system according to claim 11 wherein the wireless communication protocol is selected from the group consisting of 802.11a, 802.11b, BlueTooth and CDPD.

13. The method of remotely monitoring and controlling a manufacturing execution system according to claim 1 wherein the wireless device data includes at least a screen resolution of the wireless device and the transcoding proxy modifies the response at the transcoding proxy to a format allowing display at the screen resolution of the wireless device

14. A system for remotely monitoring and controlling production at a manufacturing facility comprising:
a manufacturing execution system connected to monitor and control the manufacturing facility;
a web server connected to the manufacturing execution system, the manufacturing execution system providing information to the web server and receiving control data from the web server;
a transcoding proxy connected to the web server, the transcoding proxy being adapted to receive a request from a wireless device, the request including wireless device data and request data, the wireless device data including information about the wireless device and the request data identifying information requested from the manufacturing execution system;
the transcoding proxy sending the request data to the web server, responsive to receipt of the request from the wireless device;
the web server sending a response to the transcoding proxy, the response including information responsive to the request data;
the transcoding proxy modifying the response, based on the wireless device data, to a format compatible with the wireless device;
the transcoding proxy sending the modified response from the transcoding proxy to the wireless device;
the transcoding proxy being adapted to receive a control command containing control data from the wireless device;
the transcoding proxy relaying the control data from the transcoding proxy to the web server; and
the web server forwarding the control data from the web server to the manufacturing execution system to control operation of the manufacturing facility through the manufacturing execution system.

15. The system for remotely monitoring and controlling production at a manufacturing facility according to claim 14 wherein the transcoding proxy stores the wireless device data at the transcoding proxy and retrieves the wireless device data before modifying the response.

16. The system for remotely monitoring and controlling production at a manufacturing facility according to claim 14 further including a wireless access point connected to the transcoding proxy, the wireless device sending the request to the transcoding proxy via the wireless access point.

17. The system for remotely monitoring and controlling production at a manufacturing facility according to claim 16 wherein the manufacturing execution system and the wireless access point are located in a manufacturing facility being controlled by the manufacturing execution system.

18. The system for remotely monitoring and controlling production at a manufacturing facility according to claim 14 wherein the transcoding proxy is connected to a computer network and the transcoding proxy receives requests from web browser software on computers connected via wires to the computer network.

19. The system for remotely monitoring and controlling production at a manufacturing facility according to claim 14 wherein the request data comprises a request for a web page from the web server.

20. The system for remotely monitoring and controlling production at a manufacturing facility according to claim 19 wherein the information responsive to the request comprises a web page encoded in extended markup language format.

21. The system for remotely monitoring and controlling production at a manufacturing facility according to claim 14 wherein the manufacturing facility is a facility for manufacturing semiconductor devices.

22 The system for remotely monitoring and controlling production at a manufacturing facility according to claim 14 wherein the wireless device is a wireless personal digital assistant.

23. The system for remotely monitoring and controlling production at a manufacturing facility according to claim 14 wherein the wireless device is a cell phone.

24. The system for remotely monitoring and controlling production at a manufacturing facility according to claim 1 wherein the request is sent from the wireless device to the transcoding proxy via a conventional wireless communication protocol.

25. The system for remotely monitoring and controlling production at a manufacturing facility according to claim 14 wherein the wireless device data includes at least a screen resolution of the wireless device and the transcoding proxy modifies the response at the transcoding proxy to a format allowing display at the screen resolution of the wireless device
